(19) United States
(12) Patent Application Publication
(10) Pub. No.: US 2002/0040326 A1
(43) Pub. Date: Apr. 4, 2002

(54) Selection of content for downloading

(75) Inventor: Michael P. Spratt, Weston Bath (GB)

Correspondence Address: HEWLETT-PACKARD COMPANY, Intellectual Property Administration, P.O. Box 272400, Fort Collins, CO, 80527-2400, US

(73) Assignee: HEWLETT-PACKARD CO.

(21) Appl. No.: 09/960,526

(22) Filed: Sep. 24, 2001

(30) Foreign Application Priority Data
Sep. 26, 2000 (GB) 0023530.9

(51) Int. Cl. G06F 17/60

(52) U.S. Cl. 705/26

(57) ABSTRACT

A method is provided for selecting categorized content items for download to a mobile device (10E). The method involves monitoring, at the device (10E), use of content items (67) downloaded to the device, in order to derive (30) usage data providing an indication of use of the content items by content-item category as indicated by category indicator information (68) associated with each item. The usage data is processed (31) to provide a category-based user-preference profile (71). Subsequent downloading of content items to the device from a content source (16E) is then controlled (32) on the basis of the preference profile (71) and the categorization of the content items available from the content source.

### FIELD OF THE INVENTION

The present invention relates to the selection of content for download to a mobile device and, more particularly, to the personalisation of the download selection according to a user's perceived tastes.

The term “content” as is used herein encompasses items of any media type, or mixture of media types, that can be downloaded to a mobile device as a data stream. Thus, the term content includes audio items (such as music tracks), video stream items, text content item, etc. Furthermore, reference to “use” of a content item at the mobile device is intended to cover any use, such as presentation to the user (playing of a music track, visual presentation of a video clip, etc), printing, onward transmission etc.

### BACKGROUND OF THE INVENTION

It is expected that entertainment will become an increasingly important service for users of mobile devices as is evidenced by the success of portable MP3 players for playing back music tracks downloaded across the internet from a content-sourcing server.

Of course, the most widely used mobile device is the mobile phone and providing entertainment as a service to the mobile phone user is likely to expand rapidly as bandwidth for downloading content over the cellular radio connection increases with the introduction of data-capable bearer services such as GPRS (General Packet Radio System) to the mobile network. Not withstanding such increase in radio bandwidth for mobile downloads, it is likely to remain more economic to effect content downloads via a download station connected to the internet through a dial-up or other wired connection, the downloaded items being stored on the device for later consumption.

FIG. 1 illustrates such an arrangement in which a mobile device 10A is shown both when in a charging cradle 11 and when in use (in FIG. 1, in order to distinguish between the mobile device in these two situations, the reference 10A is enclosed in square brackets when referring to the device in its charging cradle 11). The charging cradle 11 not only has a battery charger for re-charging the batteries of the mobile device from a power source 12, but also provides internet connectivity 13 via a dialup connection established across the Public Switched Telephone Network (PSTN) 14 to a gateway providing access to the internet 15, and thus to media content server 16 connected to the internet. The dialup access functionality can be incorporated into the mobile device itself, or integrated into the cradle, or provided as a separate entity (such as part of a PC connected between the cradle and the PSTN); furthermore, the dialup access functionality can either be dedicated to connecting to one (or more) designated content servers or generic in form allowing connection to any user-specified internet site.

By using the cradle internet connectivity 13, media items can be downloaded (see arrow 18) into memory store 17 of the mobile device [10A] whilst the latter is being recharged.

During use ofthe mobile device, the stored media items can be called up from memory and presented to the user (in the present example, the media items are music tracks that are played back to the user through headphones 20).

The mobile device 10A also has connectivity to the internet via a cellular radio network (Public Land Mobile Network, PLMN, 21). This connectivity uses a data-capable bearer service ofthe PLMN that connects to the internet 15 via a suitable gateway (not separately shown); in the case of a GSM-based PLMN, the bearer service is, for example, provided by a GPRS (General Packet Radio Service) network which enables IP (or X.25) packet data to be exchanged with mobile device 10A. The availability of the radio-based internet connection enables a user to download content items (see arrow 22) from server 16 whilst mobile, the content items being either stored in store 17 or consumed immediately.

Mobile device 10A may further be provided with a receiver for receiving digital radio broadcasts from commercial radio stations.

Given the increasing availability of content items to mobile users, the problem arises of how to tailor the selection of items presented to the user, to match the user's tastes, it being appreciated that to require the user to select each item for playback is both boring for the user and also likely to present a safety hazard in many situations. Furthermore, since downloading content via a PLMN is likely to be more expensive than downloading content via the cradle internet connection 13, and since the amount of storage space in store 17 is finite, it is desirable that the content downloaded via internet connection 13 is well chosen to match the user's tastes.

U.S. Pat. No. 5,963,916 describes a web-based server system for downloading music clips to users and for collecting data on their music preferences.

It is an object of the present invention to provide a method and apparatus for facilitating the selection of content items for downloading to a mobile device.

### SUMMARY OF THE INVENTION

According to the present invention, there is provided a method of selecting categorised content items for download to a mobile device, the method involving the steps of:

(a) monitoring, at the device, use of content items downloaded to the device by detecting both positive usage events indicative of a user's preference for a particular content item and negative usage events indicative of a user's dislike of a particular content item,

(b) deriving a category-based user-preference profile on the basis of the detected usage events and category indicator information associated with each item, the detected positive and negative usage events being respectively used to increase and decrease preferences indicated by the profile, for the content item categories associated with the content items to which the events relate; and

(c) controlling the download of content items to the device from a content source on the basis of the preference profile and the categorisation of the content items available from the content source.

Preferably, the downloading of content items in step (c) is effected over a main download channel at a download station with the content items being stored in a store of the device for later use, the method also involving the downloading of content items over a radio-based channel whilst the device is away from the download station; in this case, steps (a) and (b) advantageously take into account content downloaded via both channels.

According to another aspect of the present invention, there is provided a mobile device comprising:

a communications interface for downloading categorised content items;

a content handling subsystem for storing and playing downloaded content items to a user; and

a usage monitor for deriving usage data concerning use of the downloaded content items, the monitor comprising a first arrangement for detecting positive usage events indicative of a user's preference for a particular content item, and a second arrangement for detecting negative usage events indicative of a user's dislike of a particular content item.

According to a further aspect of the present invention, there is provided a method of selecting categorised content items for download to a mobile device, the method involving the steps of:

(a) monitoring, at the device, use of content items downloaded to the device whereby to derive usage data providing an indication of use of the content items by content-item category as indicated by category indicator information associated with each item;

(b) deriving a category-based user-preference profile on the basis of the usage data; and

(c) controlling the download of content items to the device from a content source on the basis of the preference profile and the categorisation of the content items available from the content source;

at least one of steps (b) and (c) being effected off the device.

### BRIEF DESCRIPTION OF THE DRAWINGS

Methods and apparatus, each embodying the invention, for selecting content items for download to a mobile device, will now be described, by way of non-limiting example, with reference to the accompanying diagrammatic drawings, in which:

FIG. 1 is a diagram illustrating the downloading of content items to a mobile device both through a device cradle and over a data-capable bearer service of a PLMN;

FIG. 2 is a diagram illustrating, in graphical form, an example user-preference profile;

FIG. 3 is a table showing when and where steps for implementing user-preference related content download can be effected according to embodiments ofthe present invention;

FIG. 4 is a diagram similar to FIG. 1 showing a first distribution of preference-related download functionality between the mobile device and a content server;

FIG. 5 is a diagram similar to FIG. 1 showing a second distribution of preference-related download functionality between the mobile device, a PC, and a content server;

FIG. 6 is a diagram similar to FIG. 1 showing a third distribution of preference-related download functionality between the mobile device and a content server; and

FIG. 7 is a block diagram of a mobile device and source system implementing the FIG. 6 arrangement.

### BEST MODE OF CARRYING OUT THE INVENTION

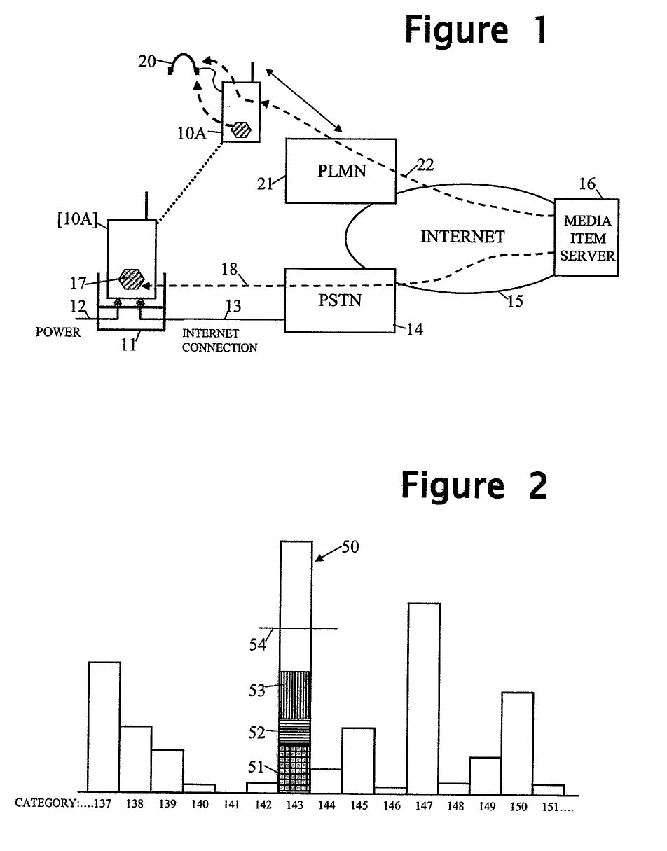

The following description relates to the downloading of music items to a mobile device, such as illustrated in FIG. 1, that has the capability of connecting to music-item servers both via a cradle-provided dialup connection and through a data-capable bearer service of a cellular radio network (such as a GSM network with a GPRS data network connecting with the public Internet). However, the present invention is not limited to content items of this type or to the form of connection used by the mobile devices to access the content servers.

In order to customise the selection of items downloaded to the mobile device, a user-preference profile is generated indicating what types of music items the user prefers. To this end, music items are categorised into an appropriate number of categories (for example, 200-1000 categories) each corresponding to a particular music type and each represented by a corresponding code; thus category code “137” could correspond to 1960's jazz and category code “343” to Big Band pre-1950's music. The categorisation scheme would preferably be adopted by all music items sources whether internet servers, broadcast radio servers, or other source. However, such universal adoption is not required and it is only necessary that one content server (one used by the mobile device) uses the categorisation scheme.

In the present example, each music item has its category code associated with it in such a way (for example, in a header) that the code is downloaded with the music item.

Given this categorisation of music items, the user-preferences profile is then built up by the steps of:

collecting usage data about how the user actually uses (plays back) the music items at the device; and

processing the usage data to ascertain which categories of music the user prefers and construct a corresponding preference profile.

The generation of the preference profile is carried out on an on-going basis—that is, it is not just effected once based on an initial sample of the user's musical tastes but is done by continual collection and analysis of the user's usage of music item with the current profile being continually updated to take account of the user's most recent behaviour.

FIG. 2 depicts, in histogram form, an example preference profile where the user's preference for each category is represented by the height of a corresponding bar, such as bar 50.

The preference profile is used to select what items are downloaded to the device at least via the cradle-based internet connection which is the primary download channel. In other words, the items chosen for download are selected according to the user's preference for particular categories of music.

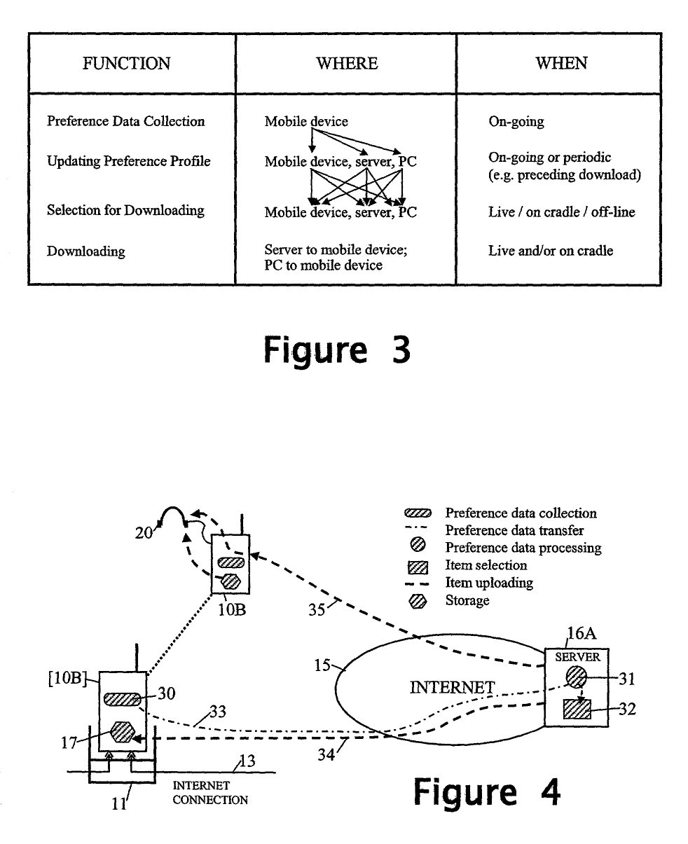

The various functions involved in this process—that is: usage data collection, profile derivation (creation/updating), download selection, and downloading—can be distributed in a variety of different ways between the mobile device, content server and other equipment, and the table shown in FIG. 3 lists the main possibilities for where and when these functions are carried out. In this table, reference to a function being carried out by a PC represents the situation where the function is carried out in a PC (or other entity) interposed between the device charging cradle 11 and the connection to the internet.

Thus, as indicated in FIG. 3, data collection is a function carried out at the mobile device since this is where item usage occurs. The function of data collection is on-going though in the cases where profile generation is effected off the device, the usage data may be off-loaded either each time a new usage event is monitored or in batches (such as when the mobile device is connected to its cradle).

The generation (including updating) of the preference profile can be effected on the device, at the content server, or at a PC with the usage data being transferred as appropriate (indicated by arrows in the FIG. 3 table). The profile can be updated after each usage event (if the usage data is available) or periodically such as immediately before the downloading of music items to the mobile device.

Selection of items for downloading can also be done on the device, at the content server, or at a PC with the profile being transferred as required (as indicated by arrows in FIG. 3). Since the content server is likely to have a large library of music items available, the selection of items is generally best done at the server since otherwise a large amount of data would need to be transferred to the device or PC to inform the selection function of the available choices. Since it is envisaged that the main download channel will be via the dialup internet connection, selection will primarily be done when the device is in its cradle; however, selection may also take place when the mobile device is “live” (that is, is away from the cradle, the download being over the radio-based channel). It is also possible to effect selection off-line—for example, the content server can decide what content items it will next download to the mobile device, when the latter is next cradled, on the basis of a stored copy of the relevant user preference profile, notwithstanding that the profile may not be fully up to date.

FIGS. 4 to 6 illustrates particular distributions of the preference functionality, each element of the functionality being depicted by a corresponding hatched shape as explained in the key accompanying each Figure.

Thus, FIG. 4 depicts the case where usage data collection (element 30) is effected at the device 10B and transferred to a music item server 16A via dialup internet connection 13 when the device is next docked in cradle 11 (see arrow 33). The server 16A includes functional element 31 for deriving the preference profile for the user concerned (identified by a user ID transferred with the usage data), and functional element 32 for effecting the selection of music items to be downloaded on the basis of the user preference profile (and possibly other factors such as a history ofthe specific music items previously downloaded to the user). The selected music items are then downloaded (arrow 33) from the server 16A to the mobile device [10B] where they are stored in store 17. The user subsequently plays back the items either by selecting individual items or, preferably, by triggering playback of items according to a play list generated either automatically or in response to user input.

The user may also elect to download (arrow 35) additional music items from server 16A over a radio-based data-capable bearer channel (established through PLMN 21, omitted for clarity from FIG. 4). Where the device includes a digital radio broadcast receiver (not shown), the user may also elect to listen to music items received through this receiver. The usage data collection function 30 is arranged to monitor all music items, regardless of source or channel of reception, that are played to the user and to collect usage data on such items provided they carry a category code (or such a code is obtainable as will be described below).

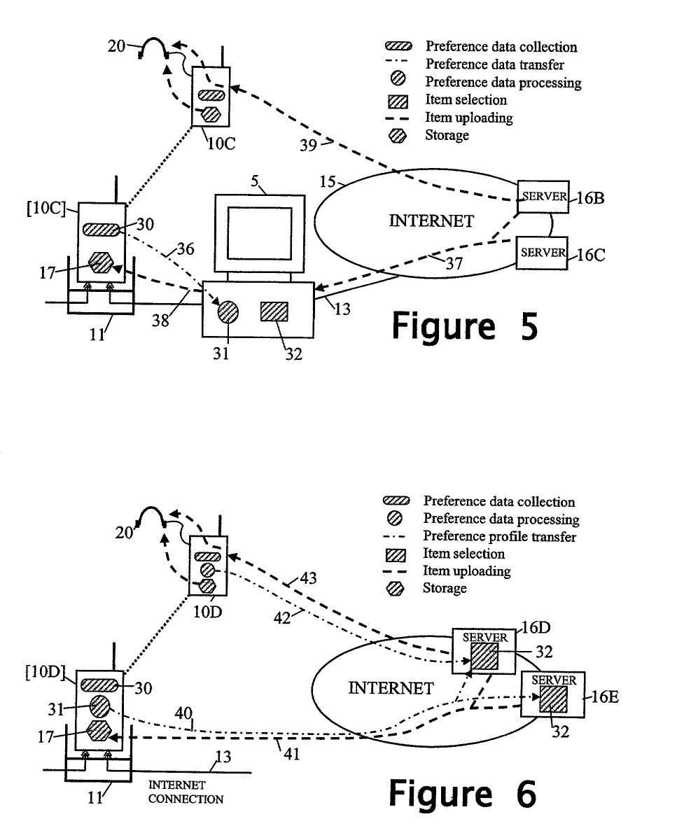

The arrangement shown in FIG. 5 is similar to that of FIG. 4 except that the functions of profile derivation 31 and download selection 32 are carried out in a PC 5 interposed between the cradle 11 and internet 15, rather than in server 16. In addition, multiple music servers 16B,C are shown, each serving categorised music items and each accessible to the mobile device 10C.

PC 5 is connected to the cradle by, for example, a USB connection so that when the mobile device [10C] is docked in cradle 11, the item usage data collected by function 30 of the mobile device 10C can be transferred from mobile device to the PC (see arrow 36) where functionality 31 uses the data to update the user preference profile. PC then connects to the internet and to one of the content servers 16B,C from where it retrieves a list of the latest available content items (this retrieval may be category limited according to categories specified by the PC in dependence on the preference profile). The selection function 32 at PC 5 now selects what items are to be downloaded and then controls the downloading of the items from the server, via the PC to the store 17 of the device [10C] (arrows 37, 38).

As with the FIG. 4 arrangement, music items can also be downloaded from server 16B (or 16C) to the device 10C over the radio-based connection (arrow 39).

In the FIG. 6 arrangement, the usage data collection function 30 and the profile derivation function 31 are both provided in the mobile device 10D, whilst the item selection function 32 is provided in music item servers 16D,E. Thus, when the device [10D] is docked in cradle 11, the user preference profile is uploaded (arrow 40) to the selected server (e.g. server 16E) and the latter selects the items for download, these items then being downloaded (arrow 41) for storage in store 17 of the mobile device.

When device 10D is not docked in cradle 11, additional content items can be downloaded (arrow 43) from the servers 16D,E and, in the present case, this download is shown as being governed by the preference profile that is uploaded over the radio link to the server (arrow 42); alternatively, the preference profile last uploaded to the server from the docked mobile device could be used to govern download via the radio channel.

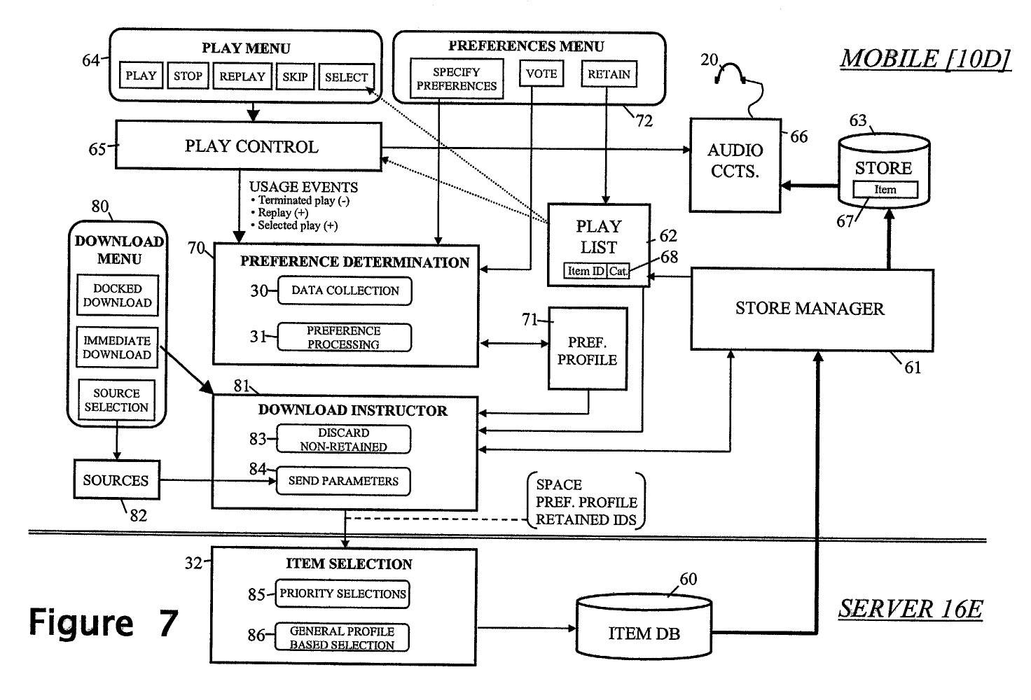

FIG. 7 is a functional block diagram of the FIG. 6 mobile device 10D and music item server 16E. When the device [10D] is docked in its cradle, and connected to the server, music items 67 are downloaded from music item database 60 over the internet to store 17, this transfer being managed in the device 10D by store manager 61. Associated with each item is identity and category information 68 which the store manager 61 extracts to form a play list 62; the play list sets a default order for playing music items absent user input to change this order.

In use of the mobile device, the user uses play menu 64 (presented via a user interface) to control the operation of play control block 65 that oversees the playback ofmusic items 67 through audio circuits 66 and headphones 20. The play menu permits the following functions to be selected:

PLAY—this plays the music item in the order specified in the play list 62, starting at the position last reached in the play list;

STOP—this stops the playback of music items;

REPLAY—replays the last preceding music item;

SKIP—skips to the next music item, interrupting any item currently being played;

SELECT—enables the user to select a specific item to play from the play list.

Preference determination block 70 comprises usage data collection block 30 and preference processing block 31. The data collection block receives usage event information from the play control 65, this information being in the form of the music category associated with the event and whether the user's reaction is positive or negative according to the event concerned. The following events are taken as positive events:

play to end of a music item,

replay of a music item,

selection for play of a music item;

whereas the following events are taken as negative events:

interruption of a music item,

skipping a music item.

The events can be equally scored or certain events can be rated more highly that others. Thus, the replay or selection of a music item can be allocated a value “2” as opposed to a value “1” allocated to “play to end”. The data collection block aggregates for each category for which a play event is generated, the value scored for the category for all events monitored between data transfers to block 31 (positive events having positive values and negative events having negative values).

The category scoring is periodically (for example, every hour or each time the device is cradled) passed to the preference profile block 31 which uses this information to create/update the preferences profile 71 for the user. This profile can simply be a value allocated to each category for which there is score, this value being increased/decreased according to the values derived from the new information provided by the block 30. Since a zero rating indicates that a particular category is not wanted, negative values in the profile can be discarded (indeed, this is preferred since to retain such values may delay the positive appearance in the profile of categories newly appreciated by the user).

A preferences menu 72 provides the user with a more direct way of inputting preference data. The following functionality is supported by the preferences menu:

SPECIFY—the user can set category values directly, this being useful both to set an initial preference profile and to subsequently immediately favour/disfavour particular categories;

VOTE—this permits a user to add emphasis to the preference rating of a particular category that is currently playing (it could also be used to de-emphasise the playing category);

RETAIN—this input relates to a specific music item rather than the item category and sets a flag against a particular item in the play list to the effect that the item is to be retained in the store at the next download. (Such an input can also be used to generate a further positive usage event for the category concerned, though the input is not strictly a usage of the item).

At the time of, or prior to, the docking of the mobile device in its cradle, the user can use download menu 80 to specify:

DOCKED DOWNLOAD—a new download is to be effected (at the next docking) taking account of the latest preferences profile and the flagging of any items for retention;

IMMEDIATE DOWNLOAD—music items are to be downloaded immediately (i.e. over a radio channel to be established to a music item server 16E);

SOURCE SELECTION—this enables a user to specify the music item server to be contacted for downloading, the user choosing, for example, from a list of available sources 82.

The user input provided via the menu 80 is fed to download instructor 81 which takes appropriate action. In the case of “Docked Download”, following docking of the device in its cradle, download instructor first determines the space available for the download having regard to the items marked for retention in the play list 62. Next, the download instructor 81 initiates connection of the device via internet connection 13 to the currently-selected music server 16E (selected using menu option “Source Selection”). The preference profile (newly updated by block 31) is transferred to the item selection functionality 32 of the music item server 16E together with an indication of the download space available in store 17 and the identities of the items being retained (so as to avoid duplication).

The item selection functionality 32 includes a priority selection block 85 which identifies priority downloads that the user may have pre-specified to the server 16E (for example, the latest recording by a particular band or of a particular musical work). This pre-specification can be effected via a normal web interface to server 16E. Priority selection may also be automatically effected on the basis of sub-category information as will be more fully described below.

Once priority selections have been identified and the music items concerned have been downloaded to the mobile device, functional block 86 is responsible for filling the remainder of the available download capacity with music items selected according their category and the user's preference profile with items retained in the store being excluded from being downloaded again. More particularly, the items for download are selected in proportion to the weighting of their corresponding categories in the preference profile. This correspondence can be such that the mix of items selected for download by block 86 directly reflects the relative preference values for the various categories in the preferences profile; alternatively, the mix of items can be chosen such that the resultant holding in the store 17, taking account of retained items (and possibly also the priority selections), corresponds to the category weighting in the profile. The balancing of the mix will normally be done for each download in isolation but may, instead, be done across several downloads.

The item selection functionality 32 will generally keep a record of the items downloaded to the mobile device, this information being used for a variety of purposes including billing, making royalty payments to copyright holders, avoidance of downloading the same item several times in succession, market survey data, etc.

As already indicated, selection of the “immediate download” option when the mobile device is undocked from its cradle, causes the download instructor 81 to initiate the establishment of a radio channel via a data-capable bearer circuit of PLMN 21 to the selected music item server for the download of one or more music items. These items can be played directly and/or stored for subsequent use; in either case, playing of these items also results in the generation of usage events that are fed to the preference determination block 70.

Where the device 16E is equipped with a broadcast radio receiver for receiving music items, if these items are broadcast with associated category codes, then the playing of these items also results in the generation of usage events fed to block 70; however, these events are preferably given a lesser value.

It will be appreciated that many variants are possible to the above-described embodiments of the present invention. Thus, for example, different music item sources could use different categorization schemes; in this case, either a separate profile is generated for each scheme or, preferably, a translation function could be provided for translating between the different schemes so as to enable a single profile to be built up; in this latter case, upon a download source being selected, the profile and categorization scheme operative at the source are matched, preferably by translation of the profile.

It is also possible to form different preference profiles for different time periods of a calendar unit—thus, a profile could be provided for every day of the week or for each part of a day (e.g. morning, afternoon, evening, night). To this end, the usage data regarding a use of an item includes a time of use indicator indicating in which time period of the calendar unit the use concerned took place. When downloading items, the profile appropriate for the current period (or near a period end, appropriate for the next period) is used to control download content selection.

Whilst in the foregoing the category of a music item has bee explicitly indicated by the association of a category code with the music item, other less direct possibilities exist for identifying the category of a music item. Thus, where a music item has an associated identifier, then its category could be determined by doing a database lookup to convert the item identifier into a category code (this lookup is effected, for example, by the preferences processing functionality 31 and is preferably done whilst the mobile device is docked and connected to the internet, it being assumed that the database concerned is one connected to the internet). The item identifier need not itself be explicit and could simply take the form of a source indicator indicating the source from which the item concerned was downloaded, and a timestamp indicating the time and data of download; provided the supplying source keeps a record of what items it has downloaded when and to whom, it would be possible to translate download source and time data into item identity and thus into category information (or, indeed, the download source and time data could be translated directly into category information if the source keeps this information with the downloaded item-identity record).

An alternative way of deriving category information is to capture an extract of the item concerned and then analyze the extract to determine the category of the item.

In order to more precisely identify the user's preferences, sub-category information concerning one or more sub-categories can be provided for each content item category, these sub-categories being the same or different across categories. Typical sub-categories include author, performer and publisher. Sub-category information is collected along with category information and is included in the user-preference profile (see FIG. 2 which depicts, with different hatching styles, the relative importance of three different preferences 51, 52 and 53 relating to a single sub-category, such as a performer sub-category, of category coded “143” and referenced 50). In selecting music items to fill the download space available for the category “143”, items are chosen from the sub-category preferences 51, 52, 53 in proportion to their relative values for the category concerned in the preferences profile. Preferably, an upper limit 54 is placed on how much of the download allocated to a particular category is filled by content items from the identified sub-category preferences whereby to retain a certain diversity of items within a category.

With sufficiently precise subcategories it is possible to identify very specific tastes of the user—for example, by using a performer subcategory, it may become evident that a user has a strong liking for a particular band. If this preference exceeds a certain threshold, it can be arranged to automatically generate a priority selection requirement for new music items from the band concerned. The priority selection requirement is then associated with the preferences profile and transferred with it for treatment as described above in relation to the priority selection box 85 in FIG. 7.

The mobile device can be provided with a speech input interface through which a user can select a particular category of content item for use, the play control then choosing a content item in this category for playback. In this case, the speech recognizer of the speech-input interface is preferably provided with information on which categories are preferred by the user as identified by the user-preference profile, this information identifying the words likely to be spoken by the user in selecting the preferred categories and thereby facilitating the recognition task of the speech recognizer.

1. A method of selecting categorised content items for download to a mobile device, the method involving the steps of:
(a) monitoring, at the device, use of content items downloaded to the device by detecting both positive usage events indicative of a user's preference for a particular content item and negative usage events indicative of a user's dislike of a particular content item,
(b) deriving a category-based user-preference profile on the basis of the detected usage events and category indicator information associated with each item, the detected positive and negative usage events being respectively used to increase and decrease preferences indicated by the profile, for the content item categories associated with the content items to which the events relate; and
(c) controlling the download of content items to the device from a content source on the basis of the preference profile and the categorisation of the content items available from the content source.

2. A method according to claim 1, wherein the positive usage events include at least one of:
the use to the end of a particular content item
the selection for use of a particular content item
the selection for re-use of a particular content item.

3. A method according to claim 1, wherein the positive usage events include the active indication by the user of a liking for a particular content item by activation of a preference indicator input.

4. A method according to claim 1, wherein the negative usage events include at least one of:
the interruption of use of content item;
the skipping of a content item.

5. A method according to claim 1, wherein the downloading of content items in step (c) is effected over a main download channel at a download station with the content items being stored in a store of the device for later use, the method also involving the downloading of content items over a radio-based channel whilst the device is away from the download station, steps (a) and (b) taking into account content downloaded via both channels.

6. A method according to claim 5, wherein the radio-based channel is a broadcast radio channel.

7. A method according to claim 5, wherein the radio-based channel is a data-capable bearer channel of a Public Land Mobile Network.

8. A method according to claim 1, wherein the mix of categories across the items downloaded in step (c) reflecting the relative preferences of the user for the various categories as indicated by the preference profile.

9. A method according to claim 1, wherein the mix of categories across items downloaded in step (c) is controlled such that, taken over several downloads, the mix of downloaded items reflects the relative preferences of the user for the various categories as indicated by the preference profile.

10. A method according to claim 1, wherein in step (c) the downloaded content items are stored in a store of the device for later use, this store already containing categorized items and the mix of categories across the items downloaded in step (c) being controlled such that the total holding of items in the store reflects the relative preferences ofthe user for the various categories as indicated by the preference profile.

11. A method according to claim 1, wherein the device includes a speech input interface through which a user can select a particular category of content item for use, the interface including a speech recognizer and the method including the further steps of:
providing to the speech recognizer, information on which categories are preferred by the user as identified by the user-preference profile whereby to facilitate recognition of the preferred categories;
receiving a spoken request via the speech recognizer for a particular category of item and selecting for use an item of the selected category.

12. A method according to claim 1, wherein step (b) is effected at the device and step (c) involves downloading the profile to said source for item selection to be effected at the source.

13. A method according to claim 1, wherein step (b) is effected at said source following the transfer of data about the detected usage events from the mobile device to the source, step (c) also being effected at the source.

14. A method according to claim 1, wherein step (b) is effected off the device following the transfer of data about the detected usage events from the device, the preferences profile when generated being loaded back to the device and step (c) being effected at the device.

15. A mobile device comprising:
a communications interface for downloading categorised content items;
a content handling subsystem for storing and playing downloaded content items to a user; and
a usage monitor for deriving usage data concerning use of the downloaded content items, the monitor comprising a first arrangement for detecting positive usage events indicative of a user's preference for a particular content item, and a second arrangement for detecting negative usage events indicative of a user's dislike of a particular content item.

16. A device according to claim 15, wherein the first arrangement comprises means for detecting the use to the end of a particular content item.

17. A device according to claim 15, wherein the first arrangement comprises means for detecting the selection for use of a particular content item.

18. A device according to claim 15, wherein the first arrangement comprises means for detecting the selection for re-use of a particular content item.

19. A device according to claim 15, wherein the first arrangement comprises means for detecting an active indication by the user of a liking for a particular content item by activation of a preference indicator input.

20. A device according to claim 15, wherein the second arrangement comprises means for detecting the interruption of use of content item.

21. A device according to claim 15, wherein the second arrangement comprises means for detecting the skipping of a content item.

22. A device according to claim 15, wherein the communications interface is arranged to upload the usage data from the usage monitor whereby to enable a remote apparatus to derive a user-preferences profile for use in selecting item for download to the device.

23. A device according to claim 15, wherein the communications interface is arranged to upload usage data from the usage monitor whereby to enable a remote apparatus to derive a user-preferences profile, the communications interface being further arranged to receive back the derived profile and use it to select items form download.

24. A method of selecting categorised content items for download to a mobile device, the method involving the steps of:
(a) monitoring, at the device, use of content items downloaded to the device whereby to derive usage data providing an indication of use ofthe content items by content-item category as indicated by category indicator information associated with each item;
(b) deriving a category-based user-preference profile on the basis of the usage data; and
(c) controlling the download of content items to the device from a content source on the basis of the preference profile and the categorisation of the content items available from the content source; at least one of steps (b) and (c) being effected off the device.

25. A method according to claim 24, wherein step (b) is effected at the device and step (c) involves downloading the profile to said source for item selection to be effected at the source.

26. A method according to claim 24, wherein step (b) is effected at said source following the transfer of said usage data to the source, step (c) also being effected at the source.

27. A method according to claim 24, wherein step (b) is effected off the device following the transfer of said usage data from the device, the preferences profile when generated being loaded back to the device and step (c) being effected at the device.

28. A method according to claim 24, wherein the downloading of content items in step (c) is effected over a main download channel at a download station with the content items being stored in a store of the device for later use, the method also involving the downloading of content items over a radio-based channel whilst the device is away from the download station, steps (a) and (b) taking into account content downloaded via both channels.

29. A method according to claim 24, wherein in step (c) the downloaded content items are stored in a store of the device for later use, this store already containing categorized items and the mix of categories across the items downloaded in step (c) being controlled such that the total holding of items in the store reflects the relative preferences of the user for the various categories as indicated by the preference profile.
